(19) United States
(12) Patent Application Publication
(10) Pub. No.: US 2012/0031975 A1
(43) Pub. Date: Feb. 9, 2012

(54) ILLUMINATION BLOCKS FOR A GRAPHICAL CODE READER

(75) Inventors: George Powell, Sandy, UT (US); Paul Hepworth, Riverton, UT (US); Ryan Hyde, Lehi, UT (US); Ryan Hoobler, Salt Lake, UT (US)

(73) Assignee: The Code Corporation, Bluffdale, UT (US)

(21) Appl. No.: 12/850,403

(22) Filed: Aug. 4, 2010

(51) Int. Cl. G06K 7/12; H05B 37/02

(52) U.S. Cl. 235/455; 315/363

(57) ABSTRACT

A system for reading graphical codes includes a graphical code reader. The graphical code reader includes an imaging engine and illumination control circuitry. The imaging engine includes a light source. The system also includes an illumination block that is removably connected to the graphical code reader. The illumination block includes a supplemental light source. The illumination control circuitry is configured to activate the light source of the imaging engine and the supplemental light source.

### BACKGROUND

A machine-readable graphical code (“graphical code”) is a graphical representation of information that consists of multiple graphical code elements having different light reflective or light emissive properties. Examples of different types of graphical codes include bar codes, data matrix codes, MaxiCodes, and so forth. Graphical codes and graphical code readers have become widely used in many commercial environments, such as point-of-sale stations in retail stores and supermarkets, inventory and document tracking, and the like.

Devices for identifying or extracting information from graphical codes are generally referred to as graphical code readers. Some graphical code readers include an imaging engine. As used herein, the term “imaging engine” refers to a combination of hardware and optical components that collectively function to capture two-dimensional images of graphical codes. During typical operation, one or more light sources within the imaging engine illuminate a target area in which a graphical code may be located. Light is reflected from the graphical code toward the graphical code reader. One or more lenses within the imaging engine focus an image of the graphical code onto an image sensor. Pixels within the image sensor are read electronically to provide a two-dimensional array of image data corresponding to the graphical code. A decoder then processes the image data and extracts the information that is contained in the graphical code.

### BRIEF DESCRIPTION OF THE DRAWINGS

FIG. 1 illustrates a system for reading graphical codes in accordance with the present disclosure;

FIG. 2 illustrates another system for reading graphical codes in accordance with the present disclosure;

FIG. 3 illustrates another system for reading graphical codes in accordance with the present disclosure; and

FIG. 4 illustrates another system for reading graphical codes in accordance with the present disclosure.

### DETAILED DESCRIPTION

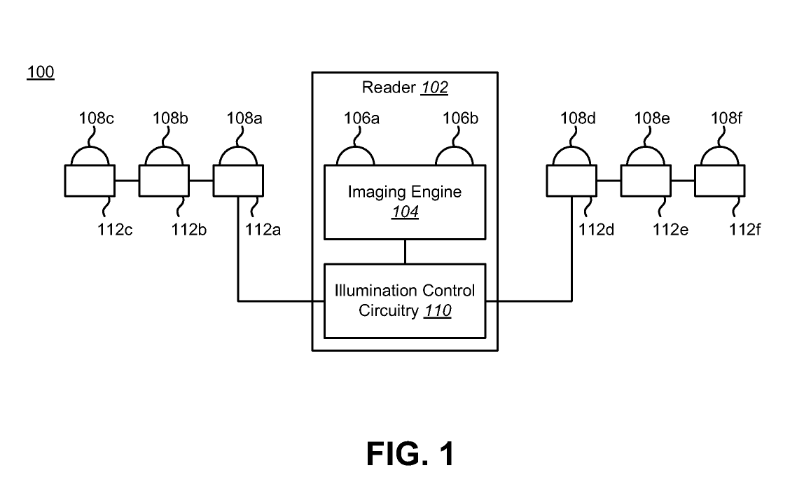

FIG. 1 illustrates a system 100 for reading graphical codes in accordance with the present disclosure. The system 100 includes a graphical code reader (“reader”) 102. The reader 102 includes an imaging engine 104. The imaging engine 104 includes two light sources 106a-b. (The number of light sources 106 is for purposes of example only; a different number of light sources 106 may be used.) The light sources 106a-b may be light-emitting diodes (LEDs).

The imaging engine 104 also includes illumination control circuitry 110 that is configured to activate the light sources 106a-b. Activating the light sources 106a-b may involve generating pulse width modulation signals for the light sources 106a-b. The illumination control circuitry 110 may be separate from the imaging engine 104, as shown. Alternatively, the illumination control circuitry 110 may be included within the imaging engine 104.

The system 100 also includes illumination blocks 112a-f and supplemental light sources 108a-f. The supplemental light sources 108a-f may be LEDs. Each illumination block 112 includes a supplemental light source 108. (The number of illumination blocks 112 within the system 100 and the number of supplemental light sources 108 within each illumination block 112 is for purposes of example only; a different number of illumination blocks 112 and/or supplemental light sources 108 may be used.)

The illumination blocks 112a-f are removably connected to the reader 102. In other words, although FIG. 1 shows the illumination blocks 112a-f as being connected to the reader 102, some or all of the illumination blocks 112a-f may be disconnected from the reader 102 and the reader 102 may operate without them.

As mentioned, the illumination control circuitry 110 is configured to activate the imaging engine's light sources 106a-b. In addition, the illumination control circuitry 110 is also configured to activate the supplemental light sources 108a-f when the illumination blocks 112a-f are connected to the reader 102.

There are some situations in which the imaging engine's light sources 106a-b may provide sufficient illumination for reading graphical codes. In these situations, the reader 102 may be used without the illumination blocks 112a-f. However, there may also be situations in which additional illumination (beyond that provided by the imaging engine's light sources 106a-b) may be helpful in order to more accurately read graphical codes. In these situations, the illumination blocks 112a-f may be connected to the reader 102 and used together with the imaging engine's light sources 106a-b.

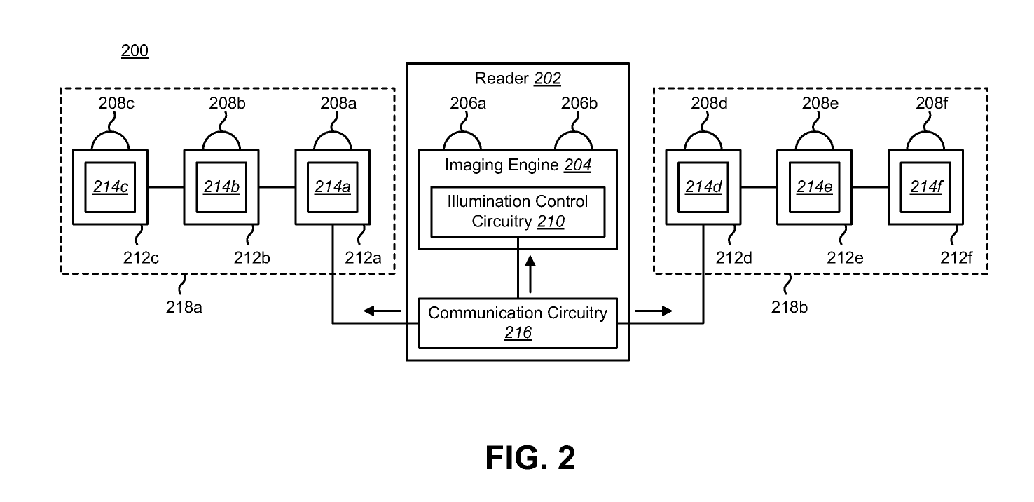

FIG. 2 illustrates another system 200 for reading graphical codes in accordance with the present disclosure. The system 200 of FIG. 2 is similar to the system 100 that was discussed above in connection with FIG. 1, except as indicated below.

In the depicted system 200, each illumination block 212 includes a supplemental light source 208 and illumination control circuitry 214 that is configured to activate the supplemental light source 208. Thus, the system 200 includes illumination blocks 212a-f, supplemental light sources 208a-f (which may be LEDs), and illumination control circuitry 214a-f for the supplemental light sources 208a-f. (The number of illumination blocks 212 within the system 200 and the number of supplemental light sources 208 within each illumination block 212 is for purposes of example only; a different number of illumination blocks 212 and/or supplemental light sources 208 may be used.)

In order to distinguish the illumination control circuitry 210 for the imaging engine's light sources 206a-b from the illumination control circuitry 214a-f for the supplemental light sources 208a-f, the illumination control circuitry 210 for the imaging engine's light sources 206a-b will be referred to as reader illumination control circuitry 210, whereas the illumination control circuitry 214a-f for the supplemental light sources 208a-f will be referred to as illumination block control circuitry 214a-f.

The reader 202 also includes communication circuitry 216. The communication circuitry 216 is configured to instruct the reader illumination control circuitry 210 to activate the imaging engine's light sources 206a-b. The reader illumination control circuitry 210 is configured to activate the imaging engine's light sources 206a-b in response to the instructions from the communication circuitry 216 of the reader 202.

The communication circuitry 216 is also configured to instruct the illumination block control circuitry 214a-f to activate the supplemental light sources 208a-f (when the illumination blocks 212a-f are connected to the reader 202). The illumination block control circuitry 214a-f is configured to activate the supplemental light sources 208a-f in response to the instructions from the communication circuitry 216 of the reader 202.

The reader 202 and the first, second, and third illumination blocks 212a-c are serially connected. Thus, it may be said that the first, second, and third illumination blocks 212a-c form a first serial chain 218a of illumination blocks 212a-c. Similarly, the reader 202 and the fourth, fifth, and sixth illumination blocks 212d-f are also serially connected. Thus, it may be said that the fourth, fifth, and sixth illumination blocks 212d-f form a second serial chain 218b of illumination blocks 212d-f.

All of the illumination blocks 212 within a particular serial chain 218 receive the same instructions from the reader 202. For example, the reader 202 is able to send instructions to cause the activation of all of the supplemental light sources 208a-c in the first serial chain 218a at the same time. However, the reader 202 is not able to send instructions to cause the activation of only the first supplemental light source 208a without also causing the activation of the second and third supplemental light sources 208b-c.

The illumination blocks 212a-c in the first serial chain 218a may receive different instructions from the reader 202 than the illumination blocks 212d-f in the second serial chain 218b. For example, the reader 202 may send activation instructions to the first serial chain 218a without also sending activation instructions to the second serial chain 218b, and vice versa.

There are some situations in which the imaging engine's light sources 206a-b may provide sufficient illumination for reading graphical codes. In these situations, the reader 202 may be used without the illumination blocks 212a-f. However, there may also be situations in which additional illumination (beyond that provided by the imaging engine's light sources 206a-b) may be helpful in order to more accurately read graphical codes. In these situations, the illumination blocks 212a-f may be connected to the reader 202 and used together with the imaging engine's light sources 206a-b.

Advantageously, additional illumination blocks 212 can be connected to either serial chain 218a-b without making any modifications to the reader 202. This provides a user of the reader 202 with a great deal of flexibility. The user is able to easily experiment with using different numbers of illumination blocks 212 until the amount of illumination is optimized for the particular environment in which the reader 202 is being used. When additional illumination blocks 212 are connected to a particular serial chain 218, the additional illumination blocks 212 receive the same instructions from the reader 202 as the other illumination blocks 212 in the chain 218. For example, if one or more additional illumination blocks 212 were connected to the first serial chain 218a, they would receive the same instructions from the reader 202 as the other illumination blocks 212a-c in the chain 218a.

In the depicted system 200, the illumination control circuitry 210 is included within the imaging engine 204. Alternatively, the illumination control circuitry 210 may be separate from the imaging engine 204.

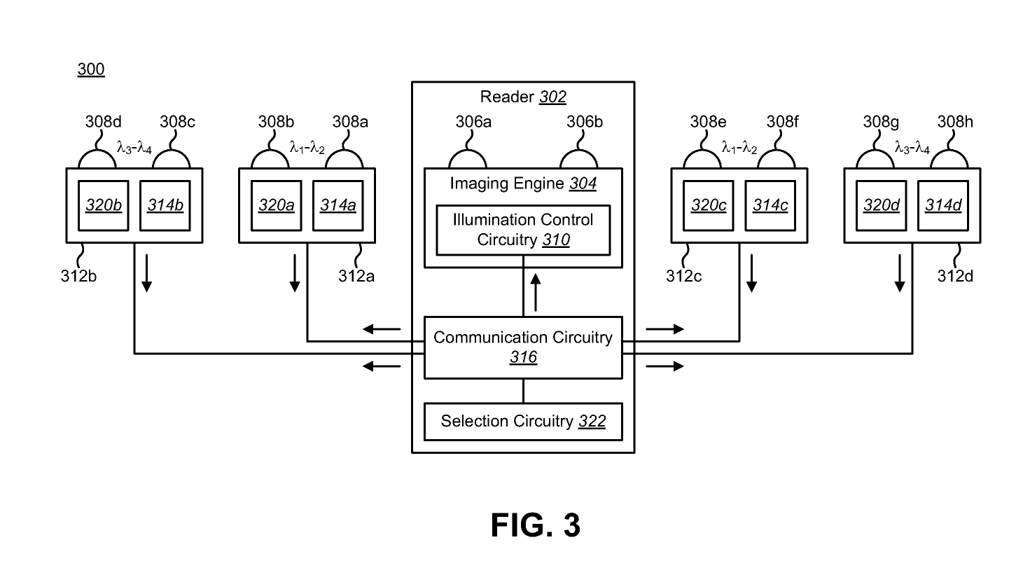

FIG. 3 illustrates a system 300 for reading graphical codes according to another embodiment of the invention. The system 300 of FIG. 3 is similar to the system 200 that was discussed above in connection with FIG. 2, except as indicated below.

In the depicted system 300, different supplemental light sources 308 emit different wavelengths of light. In particular, the first, second, fifth, and sixth supplemental light sources 308a, 308b, 308e, 308f emit light within a first range of wavelengths λ₁-λ₂. The third, fourth, seventh, and eighth supplemental light sources 308c, 308d, 308g, 308h emit light within a second range of wavelengths λ₃-λ₄.

The reader 302 is configured for at least two modes of operation. During a first mode of operation, the supplemental light sources 308a, 308b, 308e, 308f that emit light within the first range of wavelengths λ₁-λ₂ are activated, while the supplemental light sources 308c, 308d, 308g, 308h that do not emit light within the first range of wavelengths λ₁-λ₂ are not activated. During a second mode of operation, the supplemental light sources 308c, 308d, 308g, 308h that emit light within the second range of wavelengths λ₃-λ₄ are activated, while the supplemental light sources 308a, 308b, 308e, 308f that do not emit light within the second range of wavelengths λ₃-λ₄ are not activated.

For example, the first range of wavelengths λ₁-λ₂ may correspond to ultraviolet light, and the second range of wavelengths λ₃-λ₄ may correspond to red light. The reader 302 may be configured for a first mode of operation in which the supplemental light sources 308a, 308b, 308e, 308f that emit ultraviolet light are activated (e.g., for reading the watermark on paper money). The reader 302 may be configured for a second mode of operation in which the supplemental light sources 308c, 308d, 308g, 308h that emit red light are activated (e.g., for reading graphical codes).

The illumination blocks 312a-d include reporting circuitry 320a-d that is configured to report to the reader 302 about characteristics of the supplemental light sources 308a-h. The reporting circuitry 320 in a particular illumination block 312 is configured to report to the reader 302 about characteristics of the supplemental light sources 308 that are included in that illumination block 312. For example, the reporting circuitry 320a in the first illumination block 312a is configured to report to the reader 302 about characteristics of the supplemental light sources 308a-b that are included in the first illumination block 312a.

The reader 302 is configured to receive the reports from the illumination blocks 312a-d. The reader 302 includes selection circuitry 322. The selection circuitry 322 is configured to identify the supplemental light sources 308a, 308b, 308e, 308f that emit light within the first range of wavelengths λ₁-λ₂ and the supplemental light sources 308c, 308d, 308g, 308h that emit light within the second range of wavelengths λ₃-λ₄ based on the reports from the illumination blocks 312a-d.

When the reader 302 is in the first mode of operation described above, the communication circuitry 316 sends activation instructions only to the illumination block control circuitry 314a, 314c corresponding to the supplemental light sources 308a, 308b, 308e, 308f that emit light within the first range of wavelengths λ₁-λ₂. The communication circuitry 316 does not send activation instructions to the illumination block control circuitry 314b, 314d corresponding to the supplemental light sources 308c, 308d, 308g, 308h that emit light within the second range of wavelengths λ₃-λ₄.

Conversely, when the reader 302 is in the second mode of operation described above, the communication circuitry 316 sends activation instructions only to the illumination block control circuitry 314b, 314d corresponding to the supplemental light sources 308c, 308d, 308g, 308h that emit light within the second range of wavelengths λ₃-λ₄. The communication circuitry 316 does not send activation instructions to the illumination block control circuitry 314a, 314c corresponding to the supplemental light sources 308a, 308b, 308e, 308f that emit light within the second range of wavelengths λ₁-λ₂.

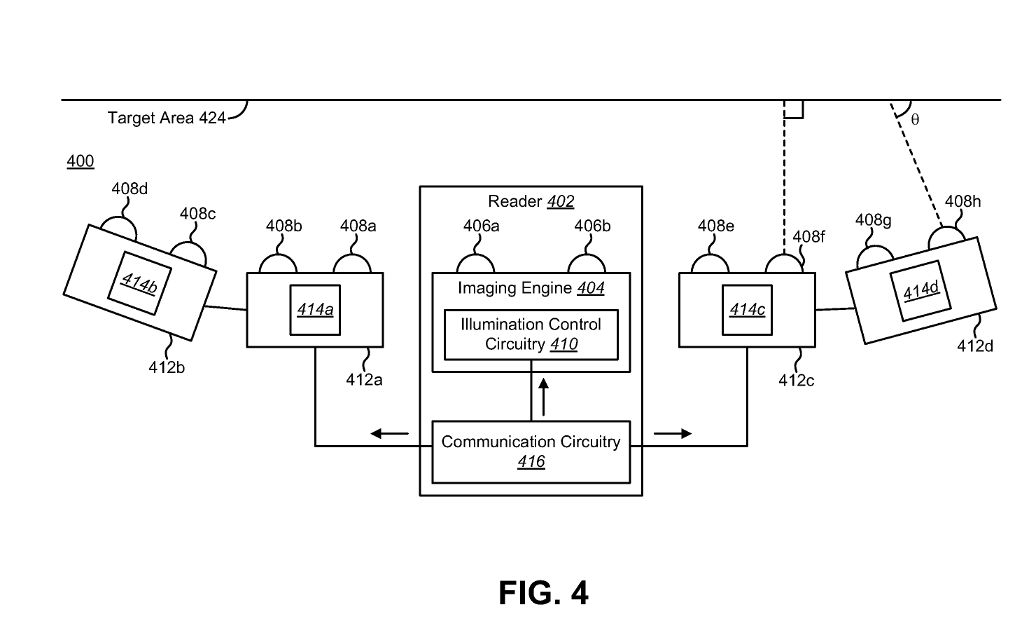

FIG. 4 illustrates another system 400 for reading graphical codes in accordance with the present disclosure. The system 400 of FIG. 4 is similar to the system 200 that was discussed above in connection with FIG. 2, except as indicated below.

In the depicted system 400, the position of the illumination blocks 412 may be adjusted so that different supplemental light sources 408 are positioned at different angles with respect to the target area 424. For example, the illumination blocks 412 may be adjusted so that some of the supplemental light sources 408a, 408b, 408e, 408f are positioned substantially perpendicular to a target area 424, while other supplemental light sources 408c, 408d, 408g, 408h are positioned at an angle θ with respect to the target area 424.

The ability to position the illumination blocks 412a-d so that different supplemental light sources 408 are positioned at different angles with respect to the target area 424 provides a user of the reader 402 with even greater flexibility. The user is able to easily experiment with the illumination blocks 412 in different positions until the direction of the illumination is optimized for the particular environment in which the reader 402 is being used.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A system for reading graphical codes, comprising:
a graphical code reader comprising an imaging engine and illumination control circuitry, wherein the imaging engine comprises a light source; and
an illumination block that is removably connected to the graphical code reader, wherein the illumination block comprises a supplemental light source;
wherein the illumination control circuitry is configured to activate the light source of the imaging engine and the supplemental light source.

2. A system for reading graphical codes, comprising:
a graphical code reader comprising an imaging engine, reader illumination control circuitry, and communication circuitry, wherein the imaging engine comprises a light source; and
an illumination block that is removably connected to the graphical code reader, wherein the illumination block comprises a supplemental light source and illumination block control circuitry;
wherein the communication circuitry is configured to instruct the reader illumination control circuitry to activate the light source of the imaging engine;
wherein the reader illumination control circuitry is configured to activate the light source of the imaging engine in response to instructions from the communication circuitry;
wherein the communication circuitry is also configured to instruct the illumination block control circuitry to activate the supplemental light source; and
wherein the illumination block control circuitry is configured to activate the supplemental light source in response to instructions from the communication circuitry.

3. The system of claim 2, wherein the system comprises a serial chain of illumination blocks, and wherein all of the illumination blocks within the serial chain receive the same instructions from the communication circuitry.

4. The system of claim 2, wherein the system comprises a first serial chain of illumination blocks and a second serial chain of illumination blocks, and wherein the illumination blocks within the first serial chain receive different instructions from the communication circuitry than the illumination blocks within the second serial chain.

5. The system of claim 2, wherein the system comprises a serial chain of illumination blocks, and wherein an additional illumination block can be connected to the serial chain without making any modifications to the reader.

6. The system of claim 2, wherein the system comprises multiple illumination blocks that are removably connected to the graphical code reader, wherein the multiple illumination blocks comprise multiple supplemental light sources, and wherein different ones of the multiple supplemental light sources emit different wavelengths of light.

7. The system of claim 2, wherein the system comprises multiple illumination blocks that are removably connected to the graphical code reader, wherein the multiple illumination blocks comprise multiple supplemental light sources, and wherein different supplemental light sources are positioned at different angles with respect to a target area.

8. The system of claim 2, wherein the system comprises multiple illumination blocks that are removably connected to the graphical code reader; and
wherein the multiple illumination blocks comprise multiple supplemental light sources, illumination block control circuitry that is configured to activate the multiple supplemental light sources, and reporting circuitry that is configured to report to the graphical code reader about characteristics of the multiple supplemental light sources.

9. The system of claim 8, wherein the graphical code reader further comprises selection circuitry that is configured to identify the supplemental light sources that have a first characteristic and the supplemental light sources that have a second characteristic based on reports from the illumination blocks;
wherein, when the graphical code reader is in a first mode of operation, the communication circuitry is configured to send activation instructions only to the illumination block control circuitry corresponding to the supplemental light sources that have the first characteristic; and
wherein, when the graphical code reader is in a second mode of operation, the communication circuitry is configured to send activation instructions only to the illumination block control circuitry corresponding to the supplemental light sources that have the second characteristic.

10. The system of claim 9, wherein the first characteristic is emission of light within a first range of wavelengths, and wherein the second characteristic is emission of light within a second range of wavelengths.

11. A graphical code reader, comprising:
an imaging engine comprising a light source;
reader illumination control circuitry that is configured to activate the light source of the imaging engine; and
communication circuitry;
wherein the graphical code reader is configured to be removably connected to an illumination block;
wherein the illumination block comprises a supplemental light source and illumination block control circuitry that is configured to activate the supplemental light source;
wherein the communication circuitry is configured to instruct the reader illumination control circuitry to activate the light source of the imaging engine;
wherein the reader illumination control circuitry is configured to activate the light source of the imaging engine in response to instructions from the communication circuitry;
wherein the communication circuitry is configured to instruct the illumination block control circuitry to activate the supplemental light source; and
wherein the illumination block control circuitry is configured to activate the supplemental light source in response to instructions from the communication circuitry.

12. The graphical code reader of claim 11, wherein the graphical code reader is configured to be removably connected to multiple illumination blocks;
wherein the multiple illumination blocks comprise multiple supplemental light sources, illumination block control circuitry that is configured to activate the multiple supplemental light sources, and reporting circuitry that is configured to report to the graphical code reader about characteristics of the multiple supplemental light sources;
wherein the graphical code reader further comprises selection circuitry that is configured to identify the supplemental light sources that have a first characteristic and the supplemental light sources that have a second characteristic based on reports from the illumination blocks;
wherein, when the graphical code reader is in a first mode of operation, the communication circuitry is configured to send activation instructions only to the illumination block control circuitry corresponding to the supplemental light sources that have the first characteristic; and
wherein, when the graphical code reader is in a second mode of operation, the communication circuitry is configured to send activation instructions only to the illumination block control circuitry corresponding to the supplemental light sources that have the second characteristic.

13. The graphical code reader of claim 12, wherein the first characteristic is emission of light within a first range of wavelengths, and wherein the second characteristic is emission of light within a second range of wavelengths.

14. An illumination block, comprising:
a supplemental light source for a graphical code reader; and
illumination control circuitry;
wherein the illumination block is configured to be removably connected to the graphical code reader; and
wherein the illumination control circuitry is configured to activate the supplemental light source in response to instructions from the graphical code reader.

15. The illumination block of claim 14, further comprising reporting circuitry that is configured to report to the graphical code reader about a characteristic of the supplemental light source.
